(19) United States
(12) Patent Application Publication
(10) Pub. No.: US 2011/0210115 A1
(43) Pub. Date: Sep. 1, 2011

(54) CONVEYOR OVEN WITH DUAL HEATER SOURCES

(75) Inventor: Jason Edward Lauer, Fort Wayne, IN (US)

(73) Assignee: MERCO/SAVORY LLC

(21) Appl. No.: 13/035,237

(22) Filed: Feb. 25, 2011

Related U.S. Application Data
(60) Provisional application No. 61/308,842, filed on Feb. 26, 2010.

(51) Int. Cl. F27D 11/00

(52) U.S. Cl. 219/388

(57) ABSTRACT

A conveyor oven and method for cooking various food products using a plurality of different heating sources, thereby avoiding costly and lengthy changeover times between different food products. Infrared heating elements and quartz heating elements are independently controlled so that both can be on at the same time or one on and the other off at the same time.

### RELATED APPLICATION

This application claims the benefit of U.S. Provisional Application Ser. No. 61/308,842, filed Feb. 26, 2010, the entire contents of which are incorporated herein by reference.

### BACKGROUND

1. Field of the Disclosure

The present disclosure relates generally to a conveyor oven and method having dual heater sources with capability of preparing a larger scope of products than conventional conveyor ovens.

2. Description of Related Art

Conventional conveyor ovens are restricted to cooking certain products in a predetermined time and at a set temperature. To increase pay back on a piece of equipment, such as a conveyor oven, it would be desirable if the operator were able to put as many different types of products through a conveyor oven as possible and as quickly as possible. That is, the more the conveyor oven runs and processes food product therethrough the faster the pay back on the cost of the equipment.

Conventional conveyor ovens require a stoppage of the equipment's usage, while the operator changes the setup parameters to run or changeover to a different type of food product therethrough. This downtime is undesirable because potential customers do not wish to wait the time required for the changeover.

Accordingly, there is a need for a conveyor oven and method for cooking different food products without a lengthy changeover.

### SUMMARY OF THE DISCLOSURE

The present disclosure overcomes the disadvantages of the prior art conveyor ovens, by providing a pair of two different heater sources, e.g., quartz and infrared heaters to allow the end user or operator to customize his or her menu without the costly and timely changeover time. The unique combination of different heater sources allows for quick changeover of products and the ability to still maintain the performance as if the conveyor oven was set to cook, brown or toast that specific product all along.

In one embodiment of the conveyor oven of the present disclosure, a housing defines an oven chamber having an inlet and an outlet. A conveyor extends through the inlet into the oven chamber and comprises a conveyor belt driven to transport food product into the oven chamber. A plurality of heating elements is disposed adjacent the conveyor belt to provide heat to cook the food product in the oven chamber. The plurality of heating elements includes at least one heating element of a first type and at least one heating element of a second type different than the first type.

In another embodiment of the conveyor oven of the present disclosure, the plurality of heating elements is disposed in a location selected from the group consisting of: above, below and above and below the conveyor belt.

In another embodiment of the conveyor oven of the present disclosure, the heating elements of the first and second types are disposed in an interleaved arrangement.

In another embodiment of the conveyor oven of the present disclosure, the interleaved arrangement comprises in order one heating element of the first type, at least two heating elements of the second type, and another heating element of the first type.

In another embodiment of the conveyor oven of the present disclosure, the first and second types are metal sheathed infrared and quartz, respectively.

In another embodiment of the conveyor oven of the present disclosure, a controller varies a percentage of operating power applied to the heating elements to tune a cooking temperature of the oven chamber based on different cooking requirements for different food products.

In another embodiment of the conveyor oven of the present disclosure, the percentage of operating power applied to heating elements of the first type is 100% or 0% and the percentage of power applied to heating elements of the second type has percentage values between 0% and 100%.

In another embodiment of the conveyor oven of the present disclosure, the controller varies the percentage by varying a duty cycle of the operating power.

In another embodiment of the conveyor oven of the present disclosure, the heating element of the second type emits radiation in the short wave spectrum.

In another embodiment of the conveyor oven of the present disclosure, the heating element of the first type emits radiation in the medium wave spectrum.

In an embodiment of the method of the present disclosure, food products are cooked in a conveyor oven having an oven chamber with an inlet and an outlet. The method comprises transporting a food product with a conveyor belt through the oven chamber, and disposing a plurality of heating elements adjacent the conveyor belt to provide heat to cook the food product in the oven chamber. The plurality of heating elements includes at least one heating element of a first type and at least one heating element of a second type different than the first type.

In another embodiment of the method of the present disclosure, the plurality of heating elements is disposed in a location selected from the group consisting of: above, below and above and below the conveyor belt.

In another embodiment of the method of the present disclosure, the heating elements of the first and second types are disposed in an interleaved arrangement.

In another embodiment of the method of the present disclosure, the interleaved arrangement comprises in order one heating element of the first type, at least two heating elements of the second type, and another heating element of the first type.

In another embodiment of the method of the present disclosure, the first and second types are metal sheathed infrared and quartz, respectively.

In another embodiment of the method of the present disclosure, the method further comprises varying a percentage of operating power applied to the heating elements to tune a cooking temperature of the oven chamber based on different cooking requirements for different food products.

In another embodiment of the method of the present disclosure, the percentage of operating power applied to heating elements of the first type is 100% or 0% and the percentage of power applied to heating elements of the second type has percentage values between 0% and 100%.

In another embodiment of the method of the present disclosure, the percentage is varied by varying a duty cycle of the operating power.

In another embodiment of the method of the present disclosure, the heating element of the second type emits radiation in the short wave spectrum.

In another embodiment of the method of the present disclosure, the heating element of the first type emits radiation in the medium wave spectrum.

The above-described and other advantages and features of the present disclosure will be appreciated and understood by those skilled in the art from the following detailed description and drawings.

### BRIEF DESCRIPTION OF THE DRAWINGS

FIG. 1 is a top side perspective view of a conveyor oven according to the present disclosure.

FIG. 2 is a schematic top view of the conveyor oven of FIG. 1.

FIG. 3 is a schematic side view of the conveyor oven of FIG. 1.

FIG. 4 is a schematic front view of the conveyor oven of FIG. 1.

FIG. 5 is a bottom side perspective view of the conveyor oven of FIG. 1 with the top portion tilted open to allow for cleaning of the components in a bottom compartment thereof.

FIG. 6 is a bottom front perspective view of the conveyor oven of FIG. 1 hinged open, thereby showing an internal view of the oven and the bottom fan thereof.

FIG. 7 is a schematic top side perspective view of the conveyor oven of FIG. 1 having a first side wall removed.

FIG. 8 is a schematic top side perspective view of the conveyor oven of FIG. 1 having a second side wall removed.

FIG. 9 is a partial top side perspective view of the conveyor oven of FIG. 1.

FIG. 10 is a schematic exploded view of the conveyor oven of FIG. 1.

FIG. 11 is a schematic diagram of the controller of the conveyor oven of FIG. 1.

### DETAILED DESCRIPTION OF THE PREFERRED EMBODIMENT

An advantage to the use of a combination of heater sources, e.g., a quartz heating element and metal sheathed infrared heating element (e.g., a metal sheathed calrod heating element), is that the end user can customize cooking menus for several food products. This combination of heating elements allows for quick changeover of products and the ability to still maintain the performance as if the oven was set to cook, brown or toast that specific product.

Quartz heating elements emit radiation in the short-wave spectrum. Metal sheathed infrared heating elements emit radiation in the medium-wave spectrum. Also, quartz heating elements are more penetrative. Metal sheathed infrared heating elements, while still producing infrared radiation, are more convective. The quartz heating elements are more reactive or quicker to respond to changes in applied power than metal sheathed infrared heating elements.

A benefit of using quartz heating elements is that the element wire inside the glass tube is able to move, expand or contract. This ability helps to maintain performance and reliability when large temperature swings are taking place. This is not the case with metal sheathed infrared heating elements. The best way to run an infrared heating element is to set its temperature and let it go. These two basic benefits allow this novel combination to process a variety of food products, that require different types of cooking, browning or toasting through the same conveyor oven without a substantial changeover delay.

The conveyor oven of the present disclosure uses metal sheathed infrared heating elements to maintain the temperature of the oven chamber or cavity and quartz heating elements to increase or decrease heat provided to the oven chamber. This allows the user to tune the conveyor oven to each product that passes therethrough.

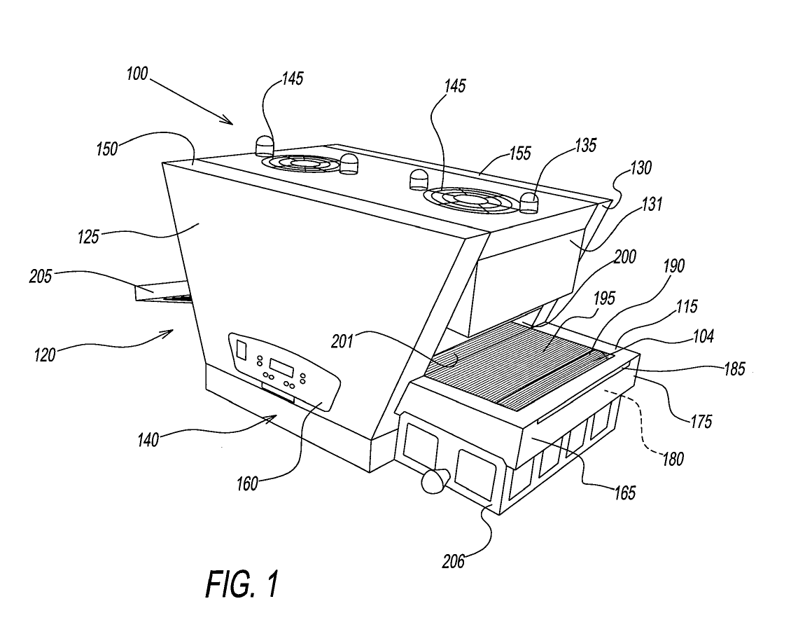

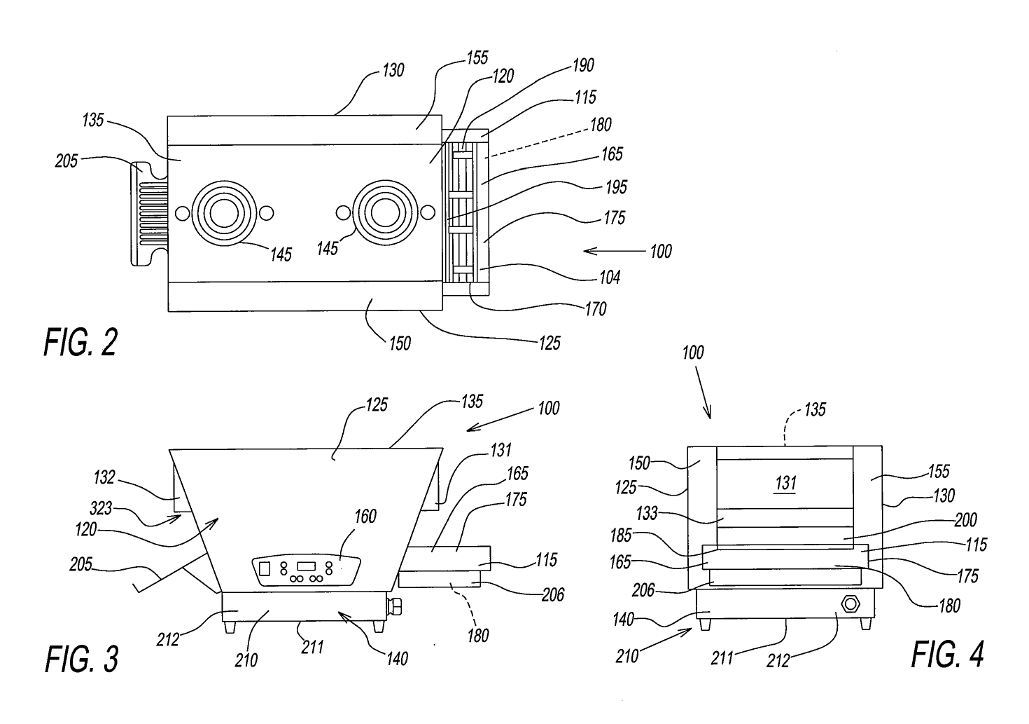

Referring to the drawings and in particular to FIGS. 1-4, an exemplary embodiment of a conveyor oven according to the present disclosure is generally referred to by reference numeral 100. Conveyor oven 100 comprises a conveyor 104, a housing 120 and a conveyor frame 115. Housing 120 has a first side wall 125, a second side wall 130, a first front wall 131, a rear wall 132, a second front wall 133, a bottom wall 225 and a top wall 135 that define an oven cavity or oven chamber 200 having an inlet 201 and an outlet 323. Housing 120 is connected to a bottom compartment 140. Top wall 135 has apertures 145. First side wall 125 covers a first compartment or side wall passage 150. Second side wall 130 covers a second compartment or side wall passage 155. A user interface 160 is disposed on first side wall 125. A user can use user interface 160 to enter data for cooking instructions or other data for conveyor oven 100. Conveyor 104 comprises a conveyor belt 195 that extends through inlet 201 into oven chamber 200 and is supported by housing 120. Conveyor frame 115 surrounds at least a portion of conveyor belt 195 that is outside inlet 201.

Conveyor frame 115 is hollow as defined by an outer wall assembly 165 and an inner wall assembly 170 that form a frame compartment or passage 175 having an interior volume 180 therebetween. Outer wall assembly 165 has apertures 185 therethrough allowing fluid communication between interior volume 180 and an ambient environment surrounding conveyor frame 115. Inner wall assembly 170 is connected to a drive shaft assembly 190, which moves conveyor belt 195. Food is placed on conveyor belt 195 by a user so that conveyor belt 195 moves the food from a position within conveyor frame 115 through oven chamber 200 to a rear tray 205. Conveyor frame 115 may be connected above an external crumb tray 206 that collects any loose debris or particles from conveyor belt 195 due to the user placing food product on conveyor belt 195.

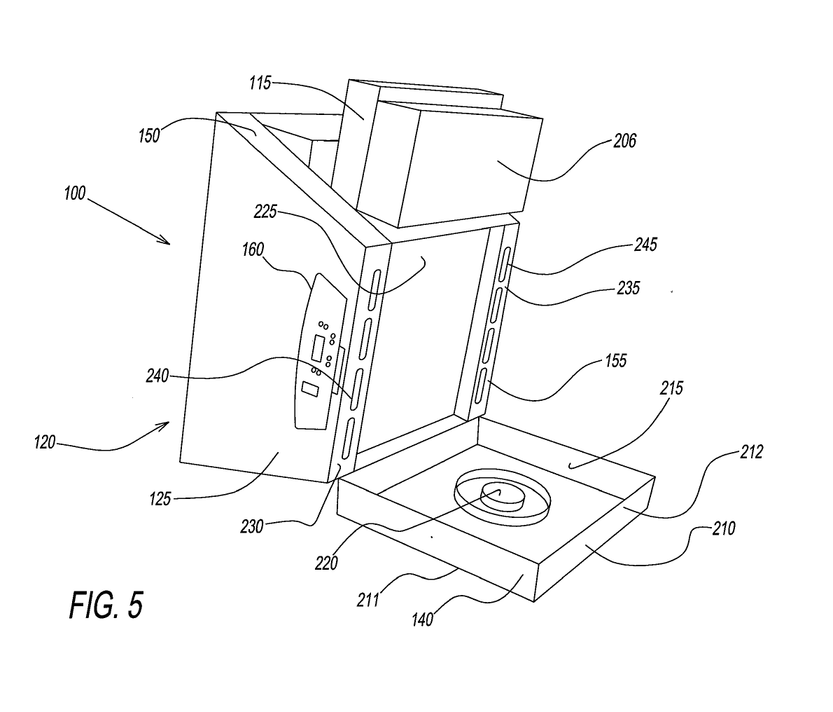

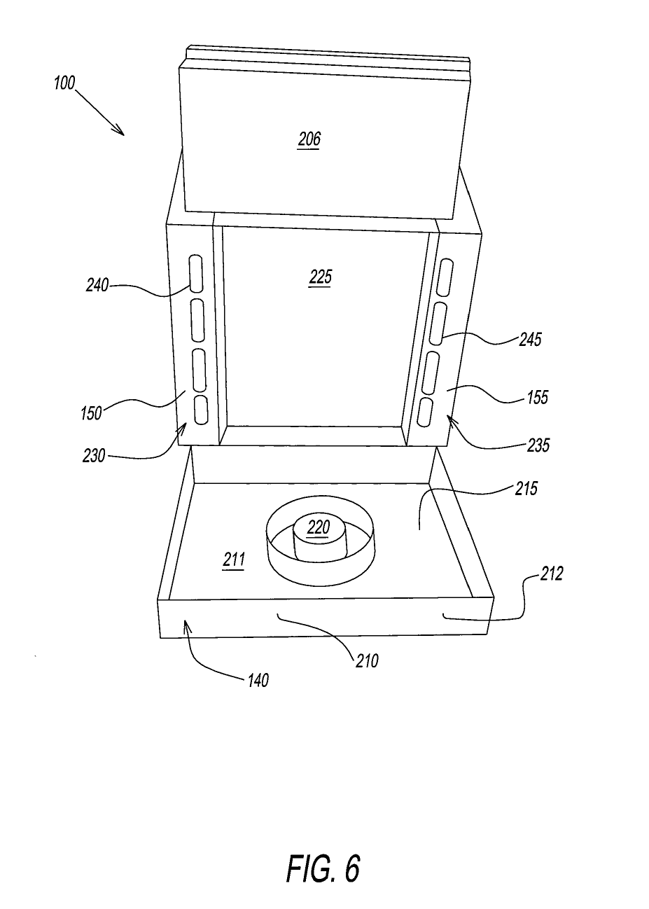

Referring now to FIGS. 3-6, bottom compartment 140 comprises a bottom housing 210 with a base wall 211 and a base side wall 212 forming a bottom interior volume 215 that houses a fan 220. When bottom compartment 140 is connected to housing 120, interior volume 215 is covered by a bottom wall 225 of housing 120 and a first bottom side wall 230 of first compartment 150 and a second bottom side wall 235 of second compartment 155. First bottom side wall 230 has apertures 240 therethrough and second bottom side wall 235 has apertures 245 therethrough to provide fluid communication between interior volume 215 and side wall compartments 150 and 155.

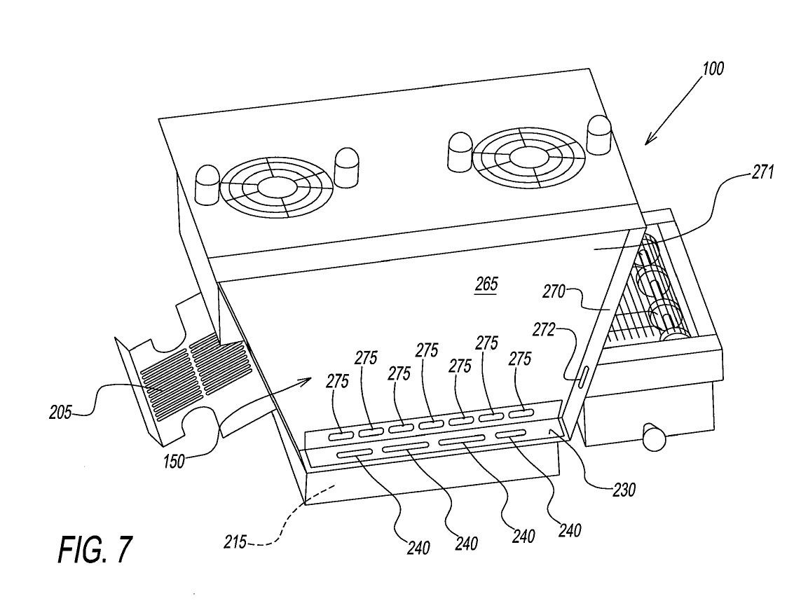

Referring now to FIG. 7, first compartment 150 has a first back panel 265 surrounded by a first compartment side wall 270 forming a first compartment interior 271. First back panel 265 has apertures 275 therethrough adjacent an edge that connects to first bottom side wall 230. First compartment side wall 270 has an aperture 272 therethrough from first compartment interior 271 to interior volume 180 in conveyor frame 115.

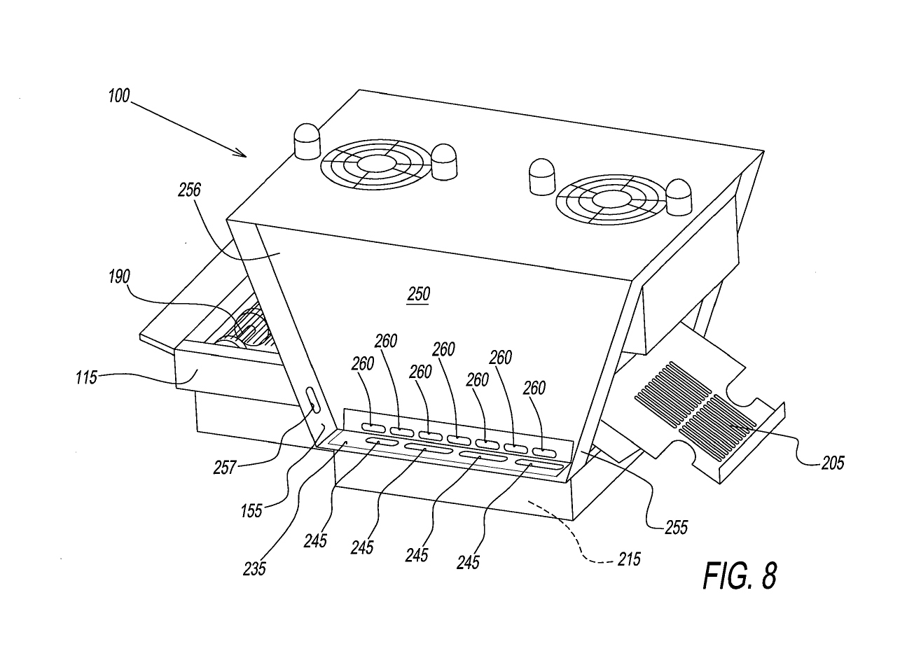

Referring now to FIG. 8, second compartment 155 has a second back panel 250 surrounded by a second compartment side wall 255 forming a second compartment interior 256. Second back panel 250 has apertures 260 therethrough adjacent an edge that connects to second bottom side wall 235. Second compartment side wall 255 has an aperture 257 therethrough from second compartment interior 256 to interior volume 180 in conveyor frame 115.

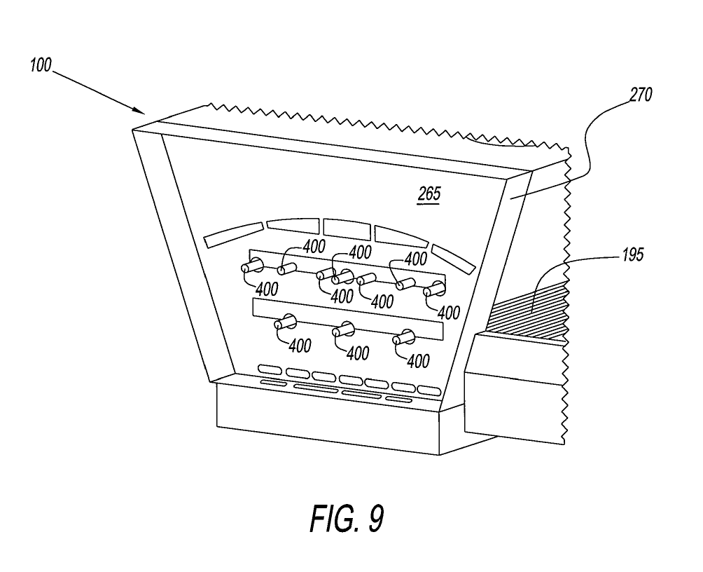

Referring to FIG. 9, a plurality of infrared heater elements 400 is disposed above and below conveyor belt 195 and supported at one their respective ends by back panel 265 of first compartment 150 and at the other ends by back panel 260 of second compartment 155 (see FIG. 8). Preferably, there are three infrared heating elements 400 above conveyor belt 195 and three infrared heater elements 400 below conveyor belt 195. A plurality of quartz heaters 404 is disposed either above and/or below conveyor belt 195. In a preferred embodiment all of the quartz heating elements are disposed above conveyor belt 195. In the preferred embodiment, quartz heating elements 404 are disposed in an interleaved arrangement with infrared heating elements 400 above conveyor belt 195. In this embodiment, the interleaved arrangement in order comprises an infrared heating element 400, two quartz heating elements, an infrared heating element, two quartz heating elements and an infrared heating element. In other embodiments the arrangement or orientation of infrared heating elements and quartz heating elements can have any suitable configuration.

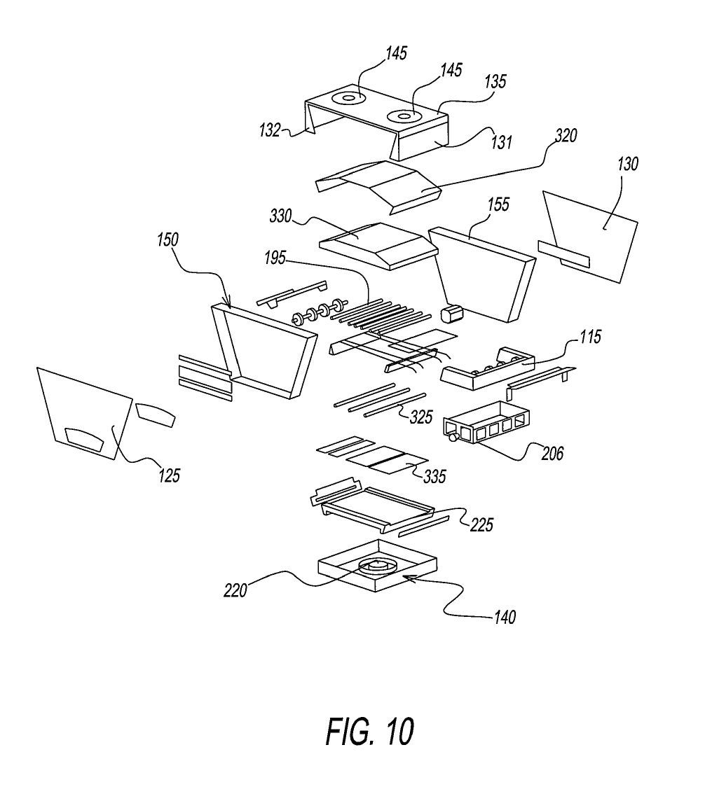

A reflector 330 shown in FIG. 10 is disposed above the interleaved arrangement of infrared heating elements and quartz heating elements. In alternate embodiments, the lower surface of a top panel 320 of conveyor oven 100, which may be sheet metal, can provide reflections that assist in the cooking, browning and toasting of the food product.

Also, in alternate embodiments, calrod heating elements may be used in place of infrared heating elements 400.

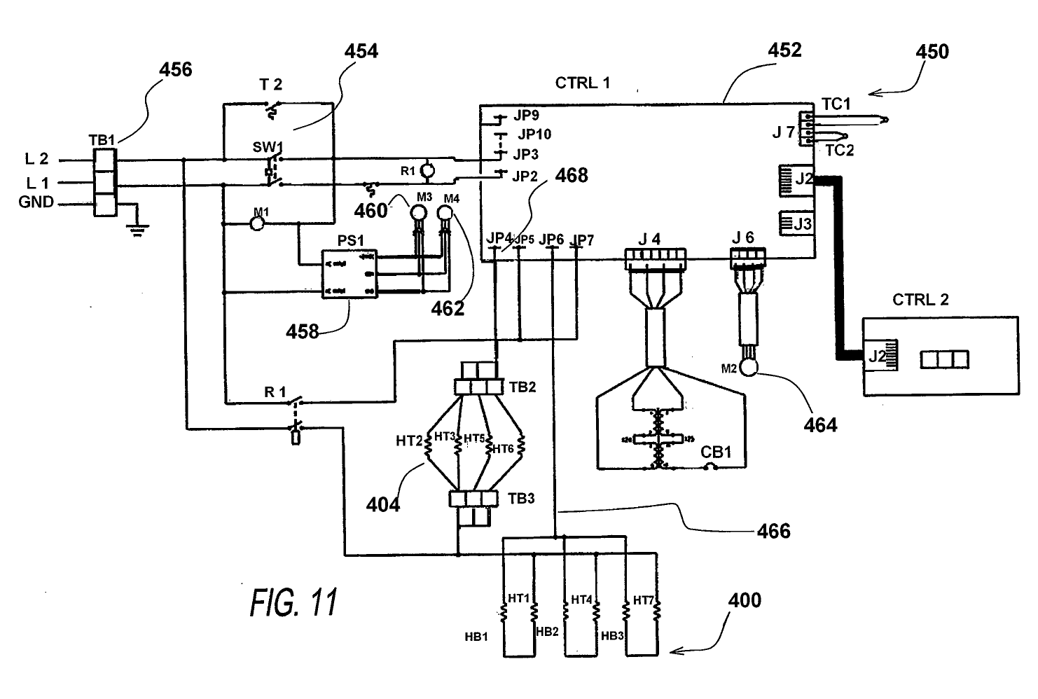

Referring FIG. 11, a controller 450 controls the turning on and off of infrared heaters 400 and quartz heaters 404, as well as motors that drive conveyor belt 195, fan 220 and other fans not germane to the present disclosure. Controller 450 can turn on all of the heating elements 400 and 195, but can be readily changed to provide for a different setting based on a percentage of operating power supplied to quartz heating elements 404 and infrared heating elements 400 depending upon the type of food product and whether it is to be cooked, browned or toasted, without having a significant changeover delay. The dual heating elements allow the operator to switch from quartz to infrared and vice versa quickly, thereby providing for heat to be maintained in the oven, thus allowing for versatility in products that can be cooked without having to bring the oven back up to temperature after a changeover. For example, the end user or operator can customize a menu without the costly and timely changeover time. The combination of different types of heating elements allows for quick changeover for different food products and the ability to still maintain the performance as if conveyor oven 100 was set to cook, brown or toast that specific food product all along. This ability allows for independent control of each heating element or type of heating element. For example, either both types of heating elements are on at the same time, one type of heating element is on and the other is off, and so on.

Still referring to FIG. 11, controller 450 comprises a control 452 that is connected via a power switch 454 to an ac power source 456. Control 450 further comprises a dc power supply 458 that is connected to power source 456 and to control fan motors 460 and 462 that drive fan 220 and another fan not germane to the present disclosure. Control 452 is connected to control a motor 464 that drives conveyor belt 195. Control 452 is also connected to provide operating power via a connection 466 to infrared heating elements 400. Control 452 is connected to provide operating power to quartz heating elements 404. Control 452 controls the percentage of operating power to infrared heating elements 400 and quartz heating elements by changing the duty cycle of the applied power, e.g., on and off times of the power. For 100%, the operating power is continuously applied. For 50%, the operating power, is switched on and off at a 50% duty cycle, i.e., on for half the duty cycle and off for the other half of the duty cycle. For 75%, the operating power is on for 75% of the duty cycle and off for 25% of the duty cycle.

Control 452 responds to entries made by a user via user interface 160 (FIGS. 1, 3 and 5) to control the operating power to infrared heating elements 400 and quartz heating elements 404. These entries may include, e.g., cook time, infrared heating element percentage and quartz heating element percentage, where the percentage is a percentage of operating power applied to the respective heating elements. Alternatively, these parameters may be included in menus that are stored in a memory (not shown) of control 452, which menus are selectable from user interface 160 by the user. In either case, control 452 includes the logic or processor to respond to the entry to control operating power to infrared heating elements 400 and quartz heating elements 404.

In a preferred embodiment, the user enters data that includes the programming or reprogramming of the heaters in a particular program for cooking a food product. Up and down temperature arrows (not shown) on user interface 160 allow the user to modify the power percentages to be supplied to infrared heating elements 400 and to quartz heating elements 404. To change the power percentage for the infrared heating elements 400, the user holds the down temperature arrow for a predetermined amount of time. As soon as the display signals the user, e.g., by blinking a display light or number, the user can change the power percentage by pressing the up or down temperature arrow. When the operator finishes programming, controller 450 automatically resets and starts using the new or updated menus or parameters.

The following example demonstrates a changeover from Menu 1 (cook time=14 seconds, quartz heating element=100%, infrared heating element=100%) to Menu 2 (cook time=10 seconds, quartz heating element=50%, infrared heating element=100%).

With Menu 1 and Menu 2 entered into control 452, an operator can operate Menu 1 and Menu 2 icons or buttons on user interface 160 depending on what food product is ordered. If Menu 1 is currently active, and a customer orders a food product that requires Menu 2, the operator simply operates the Menu 2 button. Controller 450 responds by changing the speed of conveyor belt 195 and the percentage of operating power to be applied to quartz heating elements 404 from 100% to 50%. When the food product has passed through outlet 323, the operator can leave Menu 2 alone or change back to Menu 1 by selection of the Menu 1 button. Since the infrared heating elements are set to 100% all the time, a majority of the heat is maintained in oven chamber 200. The quartz heating elements operating power percentage can be changed from one percentage to another in the range of 0% to 100% to increase or decrease the heat being supplied to oven chamber 200 in a relatively short time.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A conveyor oven for cooking food products comprising:
a housing defining an oven chamber having an inlet and an outlet;
a conveyor that extends through said inlet into said oven chamber and that comprises a conveyor belt driven to transport food product into said oven chamber; and
a plurality of heating elements disposed adjacent said conveyor belt to provide heat to cook said food product in said oven chamber, wherein said plurality of heating elements includes at least one heating element of a first type and at least one heating element of a second type different than said first type.

2. The conveyor oven of claim 1, wherein said plurality of heating elements is disposed in a location selected from the group consisting of: above, below and above and below said conveyor belt.

3. The conveyor oven of claim 1, wherein said heating elements of said first and second types are disposed in an interleaved arrangement.

4. The conveyor oven of claim 3, wherein said interleaved arrangement comprises in order one heating element of said first type, at least two heating elements of said second type, and another heating element of said first type.

5. The conveyor oven of claim 1, wherein said first and second types are metal sheathed infrared and quartz, respectively.

6. The conveyor oven of claim 1, further comprising a controller that varies a percentage of operating power applied to said heating elements to tune a cooking temperature of said oven chamber based on different cooking requirements for different food products.

7. The conveyor oven of claim 6, wherein said percentage of operating power applied to heating elements of said first type is 100% or 0% and said percentage of power applied to heating elements of said second type has percentage values between 0% and 100%.

8. The conveyor oven of claim 6, wherein said controller varies said percentage by varying a duty cycle of said operating power.

9. The conveyor oven of claim 1, wherein said heating element of said second type emits radiation in the short wave spectrum.

10. The conveyor oven of claim 9, wherein said heating element of said first type emits radiation in the medium wave spectrum.

11. A method for cooking food products in a conveyor oven having an oven chamber with an inlet and an outlet, said method comprising:
transporting a food product with a conveyor belt through said oven chamber; and
disposing a plurality of heating elements adjacent said conveyor belt to provide heat to cook said food product in said oven chamber, wherein said plurality of heating elements includes at least one heating element of a first type and at least one heating element of a second type different than said first type.

12. The method of claim 11, wherein said plurality of heating elements is disposed in a location selected from the group consisting of: above, below and above and below said conveyor belt.

13. The method of claim 11, wherein said heating elements of said first and second types are disposed in an interleaved arrangement.

14. The method of claim 13, wherein said interleaved arrangement comprises in order one heating element of said first type, at least two heating elements of said second type, and another heating element of said first type.

15. The method of claim 11, wherein said first and second types are metal sheathed infrared and quartz, respectively.

16. The method of claim 11, further comprising varying a percentage of operating power applied to said heating elements to tune a cooking temperature of said oven chamber based on different cooking requirements for different food products.

17. The method of claim 16, wherein said percentage of operating power applied to heating elements of said first type is 100% or 0% and said percentage of power applied to heating elements of said second type has percentage values between 0% and 100%.

19. The method of claim 17, wherein said percentage is varied by varying a duty cycle of said operating power.

20. The method of claim 11, wherein said heating element of said second type emits radiation in the short wave spectrum.

21. The method of claim 20, wherein said heating element of said first type emits radiation in the medium wave spectrum.
